(19) United States
(12) Patent Application Publication
(10) Pub. No.: US 2006/0240298 A1
(43) Pub. Date: Oct. 26, 2006

(54) Fuel cell temperature control apparatus

(75) Inventors: Takahiro Yamada, Kanagawa-ken (JP); Tetsuo Uozumi, Kanagawa-ken (JP)

Correspondence Address: FOLEY AND LARDNER LLP;SUITE 500, 3000 K STREET NW, WASHINGTON, DC, 20007, US

(73) Assignee: Nissan Motor Co., Ltd.

(21) Appl. No.: 10/568,287

(22) PCT Filed: Aug. 11, 2004
(86) PCT No.: PCT/JP04/11805

§ 371 Date: Feb. 16, 2006

(30) Foreign Application Priority Data
Sep. 26, 2003 (JP) 2003-336329

(51) Int. Cl. H01M 8/04

(52) U.S. Cl. 429/24; 429/26; 429/34

(57) ABSTRACT

A fuel cell temperature control apparatus controlling a temperature of a fuel cell (5) disposed in an underfloor portion (3U) of a vehicle (1) is provided with a coolant circuit (11) permitting coolant, by which a fuel cell is cooled, to flow through a heat exchanger (9, 47) disposed in a motor room (7) located at a front portion of a vehicle, a bypass circuit (17) connected to the coolant circuit and permitting the coolant to bypass the heat exchanger, and a coolant pump (19) disposed in the coolant circuit between the fuel cell and the bypass circuit so as to circulate the coolant. The bypass circuit and the coolant pump are mounted in an underfloor portion of the vehicle at a position rearward of the motor room.

### TECHNICAL FIELD

The present invention relates to a temperature control apparatus for a fuel cell and, more particularly, to a fuel cell temperature control apparatus that controls a temperature of a fuel cell which is disposed in an undefloor portion of a vehicle.

### BACKGROUND ART

Japanese Patent Application Laid-Open Publication No. 2001-71753 discloses a fuel cell powered automobile formed in a structure wherein coolant for a fuel cell is introduced into a radiator, which is disposed in a front portion of a vehicle, for heat radiation.

### DISCLOSURE OF INVENTION

However, according to the studies conducted by the present inventors, in such a structure, during warm-up operation of the fuel cell, the fuel cell and the radiator are connected to one another through a long coolant conduit and, additionally, coolant is caused to radiate heat in the radiator, resulting in a tendency with an increase in a warm-up time interval.

Therefore, the present invention has been completed with such studies conducted by the present inventors and has an object to provide a fuel cell temperature control apparatus that controls a temperature of a fuel cell, which is disposed in an undefloor portion of a vehicle, so as to shorten a time interval for which the fuel cell is warmed up.

To achieve such an object, in one aspect according to the present invention, a fuel cell temperature control apparatus controlling a temperature of a fuel cell disposed in an underfloor portion of a vehicle, comprises: a coolant circuit permitting coolant, by which a fuel cell is cooled, to flow through a heat exchanger disposed in a motor room located at a front portion of a vehicle; a bypass circuit connected to the coolant circuit and permitting the coolant to bypass the heat exchanger; and a coolant pump disposed in the coolant circuit between the fuel cell and the bypass circuit so as to circulate the coolant, wherein the bypass circuit and the coolant pump are mounted in an underfloor portion of the vehicle at a position rearward of the motor room.

On the one hand, in another aspect according to the present invention, a fuel cell temperature control apparatus controlling a temperature of a fuel cell disposed in an underfloor portion of a vehicle, comprises: circulation means for circulating coolant, by which a fuel cell is cooled, through a heat exchanger disposed in a motor room located at a front portion of a vehicle; bypass means for bypassing the heat exchanger with respect to the coolant, the bypass means being connected to the circulation means; and pump means for pumping the coolant, the pump means being disposed in the coolant circuit between the fuel cell and the bypass means so as to circulate the coolant, wherein the bypass means and the pump means are mounted in an underfloor portion of the vehicle at a position rearward of the motor room.

Other and further features, advantages, and benefits of the present invention will become more apparent from the following description taken in conjunction with the following drawings.

### BRIEF DESCRIPTION OF DRAWINGS

FIG. 1 is a schematic side view of a vehicle installed with a fuel cell temperature control apparatus of a first embodiment according to the present invention;

FIG. 2 is a schematic plan view illustrating a coolant conduit structure of the fuel cell temperature control apparatus shown in FIG. 1 of the presently filed embodiment;

FIG. 3 is a schematic plan view illustrating a structure of a fuel cell temperature control apparatus of a second embodiment according to the present invention; and

FIG. 4 is a schematic plan view illustrating a structure of a fuel cell temperature control apparatus of a third embodiment according to the present invention.

### BEST MODE FOR CARRYING OUT THE INVENTION

Hereunder, fuel cell temperature control apparatuses of various embodiments according to the present invention are described in detail with reference to the accompanying drawings.

### First Embodiment

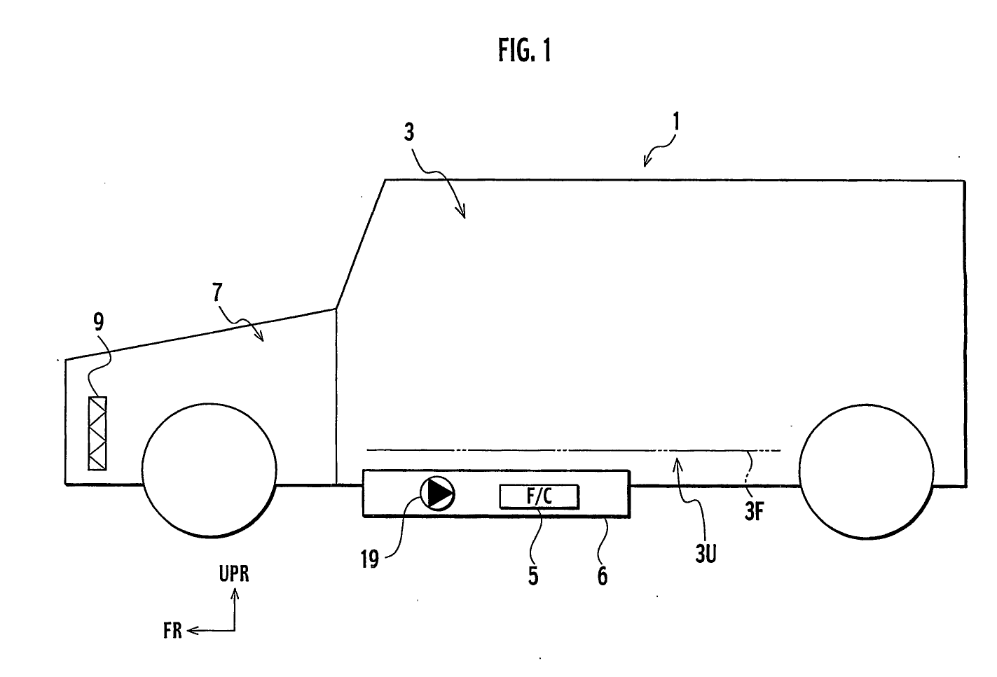

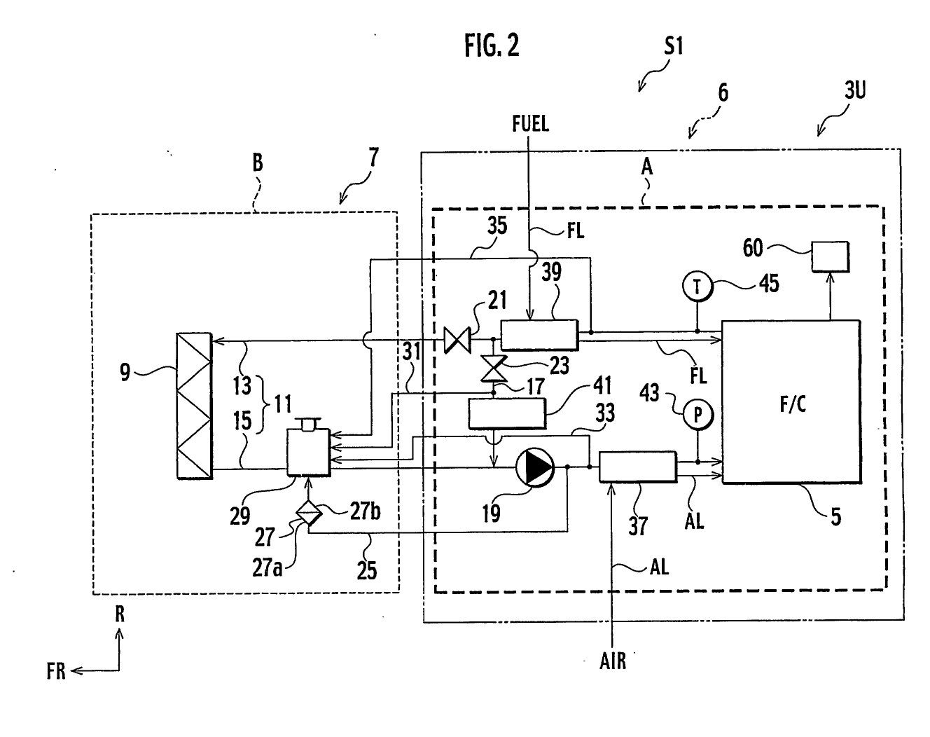

First, a fuel cell temperature control apparatus S1 of a first embodiment according to the present invention is described with reference to FIGS. 1 and 2.

FIG. 1 is a schematic side view of a vehicle on which the fuel cell temperature control apparatus of the presently filed embodiment is installed, and FIG. 2 is a schematic plan view illustrating a coolant conduit structure of such a temperature control apparatus. Incidentally, it is to be noted that reference arrows “FR”, “UPR” and “R” designate “front side”, “upper side” and “right side” of the vehicle 1, respectively, throughout the drawings.

As shown in FIG. 1, a fuel cell 5 is disposed beneath a floor 3F, of a vehicle compartment 3 of a vehicle 1, i.e., in an underfloor portion 3U. The fuel cell 5 is mounted onto a sub-frame 6, which is detachably mounted onto vehicle frame members, such as side members located in a vehicle body on a lower portion thereof at both widthwise sides of the vehicle and extending in a fore and aft direction thereof and cross members extending in a vehicle widthwise direction to interconnect the above structural members, respectively. That is, the fuel cell 5 is accommodated in the sub-frame 6.

In the meanwhile, disposed in a front area of a motor room 7 at a front portion of the vehicle is a radiator 9 that serves as a heat exchanger for radiating heat from coolant (cooling water) by which the fuel cell 5 is cooled. Incidentally disposed in the motor room 7, in addition to the radiator 9, are a vehicle drive motor (not shown), which operates with electric power supplied from the fuel cell 5 for driving the vehicle, and other auxiliary units.

The fuel cell 5 and the radiator 9 are mutually connected through a coolant circuit 11 as shown in FIG. 2. The coolant circuit 11 is comprised of a coolant outflow conduit 13 to allow coolant to flow from the fuel cell 5 to the radiator 9, and a coolant inflow conduit 15 to allow coolant to flow from the radiator 9 into the fuel cell 5. The coolant outflow conduit 13 and the coolant inflow conduit 15 are placed between the underfloor portion 3U of the vehicle compartment 3 and the motor room 7.

And, the coolant outflow conduit 13 and the coolant inflow conduit 15, both of which lie in the underfloor portion 3U beneath the vehicle compartment 3, are also connected to one another through a bypass conduit 17 that bypasses the radiator 9. Further, a coolant pump 19 is disposed in the coolant inflow conduit 15 between the bypass conduit 17 and the fuel cell 5 in the underfloor portion 3U beneath the vehicle compartment 3 to draw coolant from the radiator 9 and discharges it to the fuel cell 5. That is, these lead to a configuration where the bypass conduit 17 and the coolant pump 19 are placed together with the fuel cell 5 in the underfloor portion 3U beneath the vehicle compartment 3 at a position rearward of the motor room 7.

More particularly, the sub-frame 6 placed in the underfloor portion 3U beneath the vehicle compartment 3 accommodates component parts, surrounded by a dotted line A in FIG. 2, such as the fuel cell 5 and, additionally, the coolant pump 19 and the bypass conduit 17. On the other hand, the motor room 7 accommodates other component parts surrounded by a dotted line B.

Further, a closure valve 21 is disposed in the coolant outflow conduit 13 between the bypass circuit 17 and the radiator 9, and a bypass closure valve 23 is disposed in the bypass circuit 17, whereby opening and closing these closure valves 21, 23 allows a direction in which coolant flows to be switched over between the radiator 9 and the bypass circuit 17.

Furthermore, the coolant inflow conduit 15, between the coolant pump 19 and the fuel cell 5, and the coolant inflow conduit 15 placed in the motor room 7 are connected to one another through a branch conduit 25, and an ion removal filter 27 is disposed in the branch conduit 27 at an area located in the motor room 7. That is, this results in a configuration where the ion removal filter 27 for removing ions from coolant is placed in the motor room 7 and the coolant circuit 11 (forming the coolant inflow conduit 15) is connected to a coolant inlet portion 27a of the ion removal filter 27 through the branch conduit 25 at a discharge side of the coolant pump 19 while a coolant outlet portion 27b of the ion removal filter 27 is connected to the coolant circuit 11 (forming the coolant inflow conduit 15) at an intake side of the coolant pump 19.

And, a coolant reservoir tank 29 is disposed in a junction between the branch conduit 25, in which the ion removal filter 27 is disposed, and the coolant inflow conduit 15. The coolant reservoir tank 29 is installed in the motor room 7.

Additionally, connected to the coolant reservoir tank 29, respectively, are an air vent conduit 31, which extends from the bypass conduit 17 between the bypass closure valve 23 and the coolant inflow conduit 15, an air vent conduit 33, extending from the coolant inflow conduit 15 between the branch conduit 25 and the fuel cell 5 at a position downstream of the coolant pump 19, and an air vent conduit 35 that extends from the coolant outflow conduit 13 between the bypass circuit 17 and the fuel cell 5. The air vent conduits 31, 33, 35 serve as conduits through which air is vented from associated conduits, respectively.

Moreover, disposed in the coolant inflow conduit 15 between the air vent conduit 33 and the fuel cell 5 is an intercooler 37. The intercooler 37 functions as an air heat exchanger that achieves heat exchange with air to be supplied to the fuel cell 5 through an air supply pipe AL utilizing coolant in the coolant inflow conduit 15. That is, this results in a layout where the heat exchanger, achieving heat exchange with air to be supplied to the fuel cell 5, is located in the coolant circuit 11 downstream of the bypass circuit 17.

In the meanwhile, a hydrogen heater 39 is disposed in the coolant outflow conduit 13 between the air vent conduit 35 and the bypass circuit 17. The hydrogen heater 39 functions as a hydrogen heat exchanger that achieves heat exchange with hydrogen to be delivered to the fuel cell 5 through a hydrogen supply pipe FL utilizing coolant in the coolant inflow conduit 13. That is, this results in a layout where the heat exchanger, achieving heat exchange with hydrogen to be delivered to the fuel cell 5, is located in the coolant circuit 11 upstream of the bypass circuit 17.

Moreover, a combustor heat exchanger 41 is disposed in the bypass circuit 17 between the air vent conduit 31 and the coolant inflow conduit 15. The combustor heat exchanger 41 achieves heat exchange with a combustor 60, in which exhaust hydrogen expelled from the fuel cell 5 is combusted, utilizing coolant in the bypass circuit 17, thereby heating coolant during warm-up.

Further, a pressure gauge 43 is disposed in the coolant inflow conduit 15 at a position near the fuel cell 5 and a temperature gauge 45 is disposed in the coolant outflow conduit 13 at a position near the fuel cell 5, whereupon measured values, resulting from the pressure gauge 43 and the temperature gauge 45, are used for opening and closing operations of the closure valve 21 and the bypass closure valve 23, both of which are mentioned above, while control, inclusive of opening and closing controls of the closure valves, of the fuel cell temperature control apparatus of the presently filed embodiment is executed using a controller that is not shown.

Incidentally, such a controller, an air supply source such as a compressor (not shown) which is connected to the air supply pipe AL, a fuel tank such as a hydrogen tank (not shown), which is connected to the fuel supply pipe FL, and the combustor 60 may also be accommodated in the sub-frame 6.

Next, the operation of the fuel cell temperature control apparatus of the presently filed embodiment with the structure set forth above is described below.

First, during normal operation in which the fuel cell 5 is generating electric power, the bypass closure valve 23 is closed and in contrast, the closure valve 21 connected to the radiator 9 is opened. Under such a situation, coolant discharged from the coolant pump 19, which is driven, is repeatedly circulated to the coolant pump 19 through the fuel cell 5 and the radiator 9.

That is, under such a situation, coolant cooled by the radiator 9 is delivered to the fuel cell 5 by the coolant pump 19 so that the fuel cell 5 is cooled. Upon receipt of heat from the fuel cell 5, coolant with an increased temperature passes through the coolant outflow conduit 13 into the radiator 9 in which heat is radiated, and after radiating heat, coolant is returned to the coolant pump 19 via the coolant inflow conduit 15.

In the meanwhile, during cold start such as start-up of the fuel cell 5, the closure valve 21 is closed and the bypass valve 23 is opened. Under such a situation, coolant discharged from the coolant pump 19 during driving operation thereof passes through the fuel cell 5 and then flows through the bypass circuit 17 into the coolant pump 19.

That is, under such a situation, since coolant discharged from the fuel cell 5 is circulated so as to return to the fuel cell 5 again through the bypass circuit 17 without passing through the radiator 9, the warm-up operation of the fuel cell 5 is performed.

Further, under such a situation, the occurrence of a portion of coolant, discharged from the coolant pump 9 and branches off to flow through the branch conduit 25 to pass across the ion removal filter 27, allows ions to be removed from coolant such that an electrical conductivity of coolant is lowered. This prevents the fuel cell 5 from suffering deficiencies resulting from exposure to the ions. Of course, the ions are also similarly removed from coolant by the ion removal filter 27 even during normal operation of the fuel cell 5.

Moreover, due to the presence of coolant, which passes across the ion removal filter 27 in such a way and subsequently flows into the coolant reservoir tank 29, air introduced into coolant of the bypass circuit 17 through the air vent conduit 31 is separated to vent air if the fuel cell 5 remains in start-up operation. Similarly, introducing coolant from the air vent conduits 33, 35 connected to the coolant inflow conduit 15 and the coolant outflow conduit 13, respectively, into the coolant reservoir tank 29 enables air to be vented. Incidentally, air is also similarly vented from coolant in the coolant inflow conduit 15 and the coolant outflow conduit 13 during normal operation of the fuel cell 5.

With the fuel cell temperature control apparatus of the presently filed embodiment with such a structure mentioned above, since the bypass circuit 17, which bypasses the radiator 9, and the coolant pump 19, by which coolant is circulated, are placed together with the fuel cell 5 in the underfloor portion of the vehicle at a position rearward of the motor room 7, coolant, discharged from the fuel cell 5, is caused to flow into the bypass circuit 17 at a location near the fuel cell 5 without passing across the radiator 9 during warm-up operation of the fuel cell 5, enabling reduction in the amount of heat to be radiated from coolant and enabling the fuel cell 5 to be warmed up within a shortened period of time.

Further, since the bypass circuit 17 can be placed together with the fuel cell 5 in the vehicle underfloor portion to allow both of these component parts to be located closer to one another, the amount of coolant to be circulated when in use of the bypass circuit 17 can be decreased and the amount of coolant whose temperature is to be raised during warm-up can be decreased, enabling warm-up to be expedited in a further increased efficiency.

Furthermore, the presence of reduction in the amount of coolant to be circulated when in use of the bypass circuit 17 results in an improved controllability of a resulting discharge pressure of the coolant pump 19, thereby providing an ease of pressure control to be performed in coolant in the fuel cell 5.

Moreover, due to the presence of the ion removal filter 27 placed in the motor room 7, it becomes possible for a maintenance capability, such as replacement of the ion removal filter 27, to be improved and during warm-up, letting coolant flow through the bypass circuit 17 without passing through the radiator 9 allows the ion removal to be concurrently achieved while restricting heat radiation from coolant.

Besides, since the coolant reservoir tank 29 is located at the coolant outlet portion of the ion removal filter 27, air can be vented from coolant from which the ions have been already removed by the ion removal filter 27.

Additionally, since the coolant reservoir tank 29 and the bypass circuit 17 are connected to one another through the air vent conduit 31, it is possible for air to be reliably vented from coolant in the bypass circuit 17 located in the vehicle underfloor portion. Likewise, the presence of the other air vent conduits 33, 35 enables air to be reliably vented from coolant in the coolant inflow conduit 15 and the coolant outflow conduit 13 both of which are located in the vehicle underfloor portion.

In such a way, air is vented from coolant in both of the coolant circuit 11 and the bypass circuit 17, enabling a pressure controllability and temperature controllability of coolant in the fuel cell 5 to be improved.

Further, since the intercooler 37, which achieves heat exchange with supply air to be delivered to the fuel cell 5, is disposed in the coolant circuit 11 downstream of the bypass circuit 17, an air cooling performance can be maintained at a high level during normal operation in which coolant flows to the radiator 9 and, during a time interval in which the bypass circuit 17 is in use during start-up (warm-up), a cooling performance of air is lowered and the fuel cell 5 can be cooled by a resulting temperature of air, making it possible for the warm-up time interval to be shortened.

Furthermore, the presence of a layout, in which the hydrogen heater 39, which executes heat exchange with hydrogen to be delivered to the fuel cell 5, is disposed in the coolant circuit 11 upstream of the bypass circuit 17, results in a structure to cause the hydrogen heater 39 to be located downstream of the fuel cell 5 at a position where a coolant temperature remains at the highest level, enabling a hydrogen warm-up performance to be improved even during normal operation or during warm-up operation.

Additionally, since the combustor heat exchanger 41, which achieves heat exchange with the combustor that combusts hydrogen, is disposed in the bypass circuit 17, it becomes possible to utilize heat resulting from combustion of hydrogen expelled from the fuel cell 5 only when the bypass circuit 17 is in use, resulting in an improved warm-up performance.

Besides, due to the presence of components such as the fuel cell 5, the bypass circuit 17 and the coolant pump 19 all of which are installed in the sub-frame 6 that is detachable from the vehicle body, these component parts can be preliminarily mounted in the sub-frame 6 prior to installing these component parts to the vehicle body, achieving reduction in piping works in the motor room 7 or the vehicle underfloor portion, both of which are narrow in space, for thereby providing an ease of achieving installation work.

### Second Embodiment

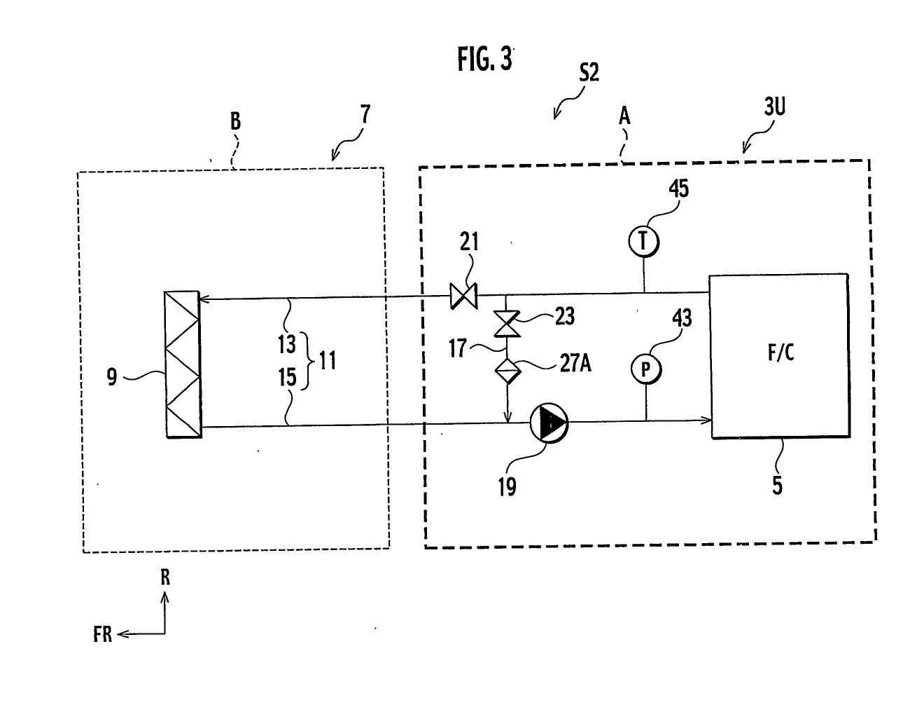

Next, a fuel cell temperature control apparatus S2 of a second embodiment according to the present invention is described with reference to FIG. 3.

FIG. 3 is a schematic plan view illustrating a coolant conduit structure for the fuel cell temperature control apparatus of the presently filed embodiment.

As shown in FIG. 3, a structure of the presently filed embodiment is fundamentally similar to the structure of the first embodiment shown in FIG. 1 in respect of the components such as the fuel cell 5 disposed in the underfloor portion 3U of the vehicle, the radiator 9 disposed in the motor room 9, the coolant circuit 11 through which the fuel cell 5 and the radiator 9 are connected, the bypass circuit 17 through which the coolant outflow conduit 13 and the coolant inflow conduit 15, both of which are placed in the vehicle underfloor portion, are connected, and the coolant pump 19, but differs in that an ion removal filter 27A is disposed in the bypass circuit 17. Hereunder, description is made of the presently filed embodiment focusing attention on such a difference, and like component parts bear like reference numerals to omit or simplify description. Incidentally, the branch conduit 25, the coolant reservoir tank 29, the air vent conduits 31, 33, 35, the intercooler 37, the hydrogen heater 39 and the combustor heat exchanger 41 are herein omitted.

More particularly, the presently filed embodiment focuses attention on a structure in that during start-up of the fuel cell 5, ions are solved out into coolant in large quantity when the fuel cell 5 remains in its halt state and a need arises to positively eliminate the ions from coolant during start-up of the fuel cell 5, and to this end, the ion removal filter 27A is disposed in the bypass circuit 17.

With such a structure, since coolant is caused to flow through the bypass circuit 17 for the purpose of warm-up during start-up of the fuel cell 5, the presence of the ion removal filter 27A placed in the bypass circuit 17 permits the ions to be removed from coolant resulting when the fuel cell 5 is started up.

As set forth above, with the structure of the presently filed embodiment, the ions, resulting when the fuel cell 5 is started up, can be reliably removed from coolant by the ion removal filter 27A disposed in the bypass circuit 17.

Further, the use of the bypass circuit 17 reduces the amount of coolant to be circulated and, hence, the ions can be removed from coolant in a further reliable and effective fashion.

Furthermore, since the flow rate of coolant decreases during such ion-removal operation, pressure loss is suppressed and it becomes suffice for the coolant pump 19 to have a pumping capacity with no needlessly increased augmentation.

### Third Embodiment

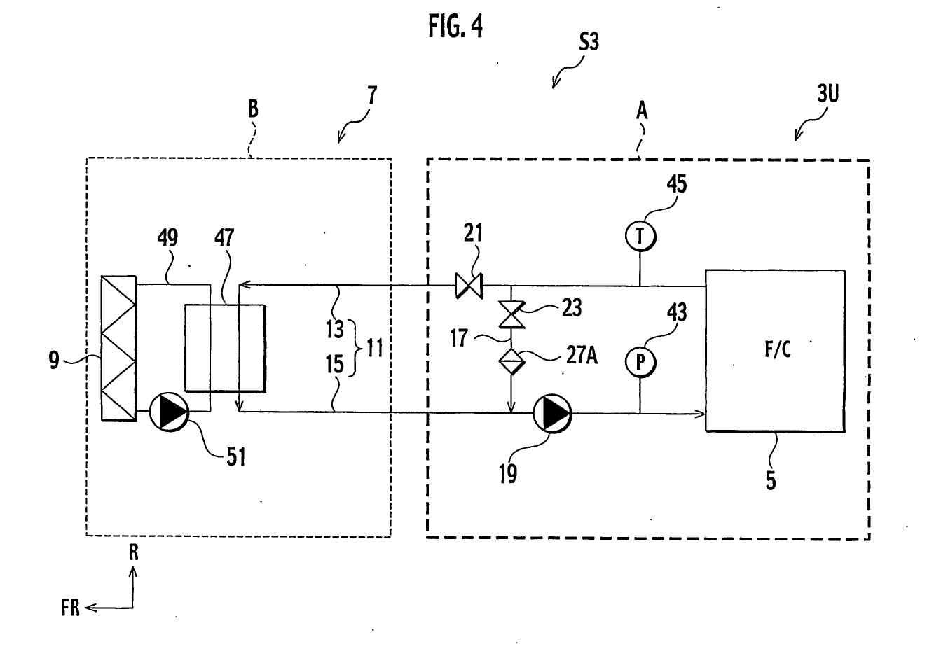

Next, a fuel cell temperature control apparatus S3 of a third embodiment according to the present invention is described with reference to FIG. 4.

FIG. 4 is a schematic plan view illustrating a coolant conduit structure for the fuel cell temperature control apparatus of the presently filed embodiment.

As shown in FIG. 4, a structure of the presently filed embodiment is further different from the second embodiment in that an intermediate heat exchanger 47 is additionally provided, as a heat exchanger placed in the motor room 7, between the fuel cell 5 and the radiator 9. Hereunder, description is made of the presently filed embodiment focusing attention on such a difference, and like component parts bear like reference numerals to omit or simplify description.

More particularly, the coolant circuit 11 is connected to the intermediate heat exchanger 47, and the intermediate heat exchanger 47 and the radiator 9 are connected to one another through a radiator conduit 49. Disposed in the radiator conduit 49 is a secondary coolant pump 51 by which coolant is circulated between the radiator 9 and the intermediate heat exchanger 47. This allows coolant, heated by the fuel cell 5, to radiate heat in the radiator 9 through the intermediate heat exchanger 47.

Incidentally, it is, of course, possible for such an intermediate heat exchanger 47 to be applied to the structure of the first embodiment.

As set forth above, the presently filed embodiment takes the form of a structure wherein coolant is not directly cooled by the radiator 9 but is cooled through heat exchange executed by the intermediate heat exchanger 47, resulting in a capability of realizing a structure with a high degree of freedom in design on consideration of performances of the radiator 9 and the intermediate heat exchanger 47 as well as an installation capability and maintenance capability within the motor room 7. Specifications of the radiator 9 and the intermediate heat exchanger 47 may be appropriately designed while taking into consideration various factors, such as an increase in weight, resulting from provisions of the intermediate heat exchanger 47 and the secondary coolant pump 51, an affect on installation capability of various component parts, electric power consumption and an increase in acoustic vibration resulting from the secondary coolant pump 51 being operated.

Summarizing the above, according to the present invention, due to a layout wherein the fuel cell, disposed in the vehicle underfloor portion, and the heat exchanger, disposed in the motor room in the front portion of the vehicle, are connected to one another by the coolant circuit whereupon the bypass circuit, which bypasses the heat exchanger, and the coolant pump, through which coolant is circulated, are disposed in the vehicle underfloor portion at a location rearward of the motor room, coolant discharged from the fuel cell is admitted to the bypass circuit in an area near the fuel cell without passing through the heat exchanger, enabling reduction in the amount of heat to be radiated from coolant while making it possible to warm up the fuel cell within the shortened time period.

Further, since the bypass circuit can be placed together in the vehicle underfloor portion to allow these component parts to remain closer to one another, the amount of coolant to be circulated when in use of the bypass circuit can be decreased while enabling reduction in the amount of coolant whose temperature is to be raised during warm-up, enabling warm-up to be achieved in a further promoted fashion.

Moreover, the presence of reduction in the amount of coolant to be circulated when in use of the bypass circuit provides an improvement over coolant pressure controllability in discharge pressure of the coolant pump, providing an ease of pressure control of coolant in the fuel cell.

The entire content of a Patent Application No. TOKUGAN 2003-336329 with a filing date of Sep. 26, 2003 in Japan is hereby incorporated by reference.

Although the invention has been described above by reference to a certain embodiment of the invention, the invention is not limited to the embodiment described above. Modifications and variations of the embodiment described above will occur to those skilled in the art, in light of the teachings. The scope of the invention is defined with reference to the following claims.

### INDUSTRIAL APPLICABILITY

As set forth above, according to the present invention, a fuel cell temperature control apparatus is obtained wherein a fuel cell, disposed in a vehicle underfloor portion, and a heat exchanger, disposed in a motor room in front a vehicle, are connected to one another through a coolant circuit and a bypass circuit, which bypasses the heat exchanger, and a coolant pump, through which coolant is circulated, are disposed in the vehicle underfloor portion at a location rearward of the motor room. Thus, such a temperature control apparatus may be applied to a variety of fuel cell apparatuses and expected to have applications in a wide range involving a fuel cell powered automobile.

1. A fuel cell temperature control apparatus controlling a temperature of a fuel cell disposed in an underfloor portion of a vehicle, comprising:
a coolant circuit permitting coolant, by which a fuel cell is cooled, to flow through a heat exchanger disposed in a motor room located at a front portion of a vehicle;
a bypass circuit connected to the coolant circuit and permitting the coolant to bypass the heat exchanger; and
a coolant pump disposed in the coolant circuit between the fuel cell and the bypass circuit so as to circulate the coolant,
wherein the bypass circuit and the coolant pump are mounted in an underfloor portion of the vehicle at a position rearward of the motor room.

2. The fuel cell temperature control apparatus according to claim 1, further comprising an ion removal filter for removing ions from the coolant.

3. The fuel cell temperature control apparatus according to claim 2, wherein the ion removal filter is disposed in the bypass circuit.

4. The fuel cell temperature control apparatus according to claim 2, wherein the ion removal filter is disposed in a branch circuit that is branched off from the coolant circuit at a discharge side of the coolant pump and connected to the coolant circuit at an intake side of the coolant pump.

5. The fuel cell temperature control apparatus according to claim 4, wherein the ion removal filter is disposed in the motor room.

6. The fuel cell temperature control apparatus according to claim 5, further comprising a coolant reservoir tank disposed in the coolant circuit at the motor room,
wherein the coolant passing across the ion removal filter is delivered to the coolant reservoir tank.

7. The fuel cell temperature control apparatus according to claim 1, further comprising an air heat exchanger disposed in the coolant circuit downstream of the bypass circuit to perform heat exchange with air to be supplied to the fuel cell.

8. The fuel cell temperature control apparatus according to claim 1, further comprising a hydrogen heat exchanger disposed in the coolant circuit upstream of the bypass circuit to perform heat exchange with hydrogen to be supplied to the fuel cell.

9. The fuel cell temperature control apparatus according to claim 1, further comprising a combustor heat exchanger disposed in the bypass circuit to perform heat exchange with a combustor in which exhaust hydrogen expelled from the fuel cell is combusted.

10. The fuel cell temperature control apparatus according to claim 1, wherein the heat exchanger includes a radiator by which the coolant is cooled by a running wind of the vehicle.

11. The fuel cell temperature control apparatus according to claim 10, wherein the heat exchanger includes an intermediate heat exchanger disposed between the radiator and the fuel cell.

12. The fuel cell temperature control apparatus according to claim 1, wherein the fuel cell is installed in an accommodating member that is detachable from a vehicle body.

13. The fuel cell temperature control apparatus according to claim 12, wherein the bypass circuit and the coolant pump are mounted in the accommodating member.

14. A fuel cell temperature control apparatus controlling a temperature of a fuel cell disposed in an underfloor portion of a vehicle, comprising:
circulation means for circulating coolant, by which a fuel cell is cooled, through a heat exchanger disposed in a motor room located at a front portion of a vehicle;
bypass means for bypassing the heat exchanger with respect to the coolant, the bypass means being connected to the circulation means; and
pump means for pumping the coolant, the pump means being disposed in the coolant circuit between the fuel cell and the bypass means so as to circulate the coolant,
wherein the bypass means and the pump means are mounted in an underfloor portion of the vehicle at a position rearward of the motor room.
